(19) United States
(12) Patent Application Publication
(10) Pub. No.: US 2018/0331900 A1
(43) Pub. Date: Nov. 15, 2018

(54) RECONFIGURABLE DEVICE MANAGER

(71) Applicant: Intel Corporation, Santa Clara, CA (US)

(72) Inventors: Utkarsh Y. Kakaiya, Folsom, CA (US); Joshua D. Fender, East York (CA); Joseph Grecco, Sadde Brook, NJ (US); Prashant Sethi, Folsom, CA (US); Nagabhushan Chitlur, Portland, OR (US); Pratik M. Marolia, Hillsboro, OR (US); Henry M. Mitchel, Wayne, NJ (US)

(73) Assignee: Intel Corporation, Santa Clara, CA (US)

(21) Appl. No.: 15/592,799

(22) Filed: May 11, 2017

(51) Int. Cl. H04L 12/24; G06F 9/455

(52) U.S. Cl. CPC H04L 41/0813; H04L 12/40; G06F 9/455

(57) ABSTRACT

An embodiment of a device manager apparatus may include a request processor to process a request for a reconfiguration of a reconfigurable device, a configuration controller communicatively coupled to the request processor to reconfigure the reconfigurable device based on the request, and a pseudo-device manager communicatively coupled to the request processor to create a pseudo device based on the request which corresponds to a functionality of the reconfiguration.

### TECHNICAL FIELD

Embodiments generally relate to data processing systems. More particularly, embodiments relate to a reconfigurable device manager.

### BACKGROUND

A reconfigurable device such as a field programmable gate array (FPGA) may be reconfigured to provide different hardware functionality. A data center may include and/or utilize a number of FPGA devices. Some data centers may permit a FPGA device to be reconfigured at the request of an end user. This practice is sometimes referred to as FPGA-as-a-Service (FaaS).

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a device manager apparatus according to an embodiment;

FIGS. 3A to 3C are flowcharts of an example of a method of managing a device according to an embodiment;

FIG. 4 is a block diagram of an example of a reconfigurable device according to an embodiment;

FIG. 5 is a block diagram of an example of a software architecture according to an embodiment;

FIG. 6 is a block diagram of another example of a reconfigurable device according to an embodiment;

FIG. 7 is a block diagram of an example of a virtualization environment according to an embodiment;

FIGS. 8 and 9 are block diagrams of examples of device manager apparatuses according to embodiments;

FIG. 10 is a block diagram of an example of a processor according to an embodiment; and

FIG. 11 is a block diagram of an example of a system according to an embodiment.

### DESCRIPTION OF EMBODIMENTS

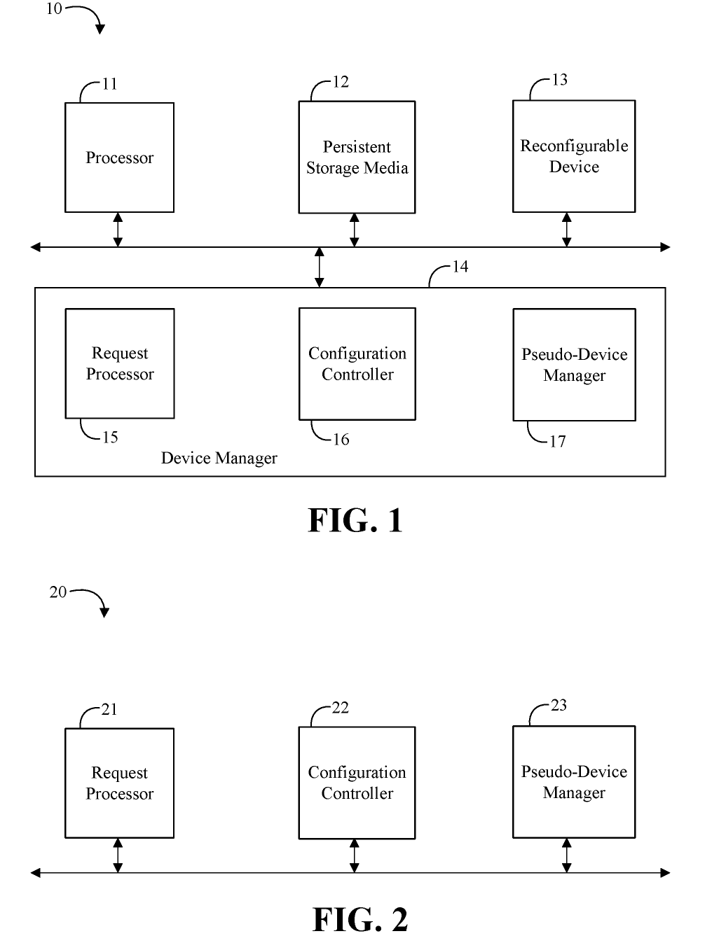

Turning now to FIG. 1, an embodiment of an electronic processing system 10 may include a processor 11, persistent storage media 12 communicatively coupled to the processor 11, a reconfigurable device 13 communicatively coupled to the processor 11, and a device manager 14 communicatively coupled to the reconfigurable device 13 to dynamically reconfigure the reconfigurable device 13 at runtime. The device manager 14 may also be communicatively coupled to the processor 11. The device manager 14 may include a request processor 15 to process a request for a reconfiguration of the reconfigurable device 13, a configuration controller 16 to reconfigure the reconfigurable device 13 based on the request, and a pseudo-device manager 17 to create a pseudo device based on the request which corresponds to a functionality of the reconfiguration (e.g., as described in more detail below). In some embodiments, the pseudo-device manager 17 may be further configured to create a virtual bus to access the functionality of the pseudo device. For example, the pseudo-device may be a virtual device or may appear to be a physical device. In some embodiments, the request processor 15 may comprise one or more of a host interface and/or a network interface.

Embodiments of each of the above processor 11, persistent storage media 12, reconfigurable device 13, device manager 14, request processor 15, configuration controller 16, pseudo-device manager 17, and other system components may be implemented in hardware, software, or any suitable combination thereof. For example, hardware implementations may include configurable logic such as, for example, programmable logic arrays (PLAs), FPGAs, complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the persistent storage media 12 may store a set of instructions which when executed by the processor 11 cause the system 10 to implement one or more components or aspects of the system 10 (e.g., the device manager 14, the request processor 15, the configuration controller 16, the pseudo-device manager 17, etc.).

Turning now to FIG. 2, an embodiment of a device manager apparatus 20 may include a request processor 21 to process a request for a reconfiguration of a reconfigurable device, a configuration controller 22 communicatively coupled to the request processor 21 to reconfigure the reconfigurable device based on the request, and a pseudo-device manager 23 communicatively coupled to the request processor 21 to create a pseudo device based on the request which corresponds to a functionality of the reconfiguration. For example, the pseudo-device may be a virtual device or may appear to be a physical device. The pseudo-device manager 23 may also be configured to destroy a previously created pseudo device based on the request. For example, the pseudo-device manager 23 may be further configured to create a virtual bus to access the functionality of the pseudo device.

In some embodiments, the pseudo-device manager 23 may be configured to create the pseudo device in compliance with an OS. For example, the pseudo-device manager 23 may assign a device class to the pseudo device that corresponds to an OS driver for the device class. In any of the foregoing examples, the request processor 21 may include a host interface. Alternatively, or additionally, in some embodiments the request processor 21 may include a network interface. In a virtualization environment, for example, the request processor 21 may comprise a virtualized interface and the configuration controller may comprise a virtualized configuration controller. For the virtualization environment, for example, some embodiments may further include a mapping layer to map function interface resources to the virtualized interface.

Embodiments of each of the above request processor 21, configuration controller 22, pseudo-device manager 23, and other components of the apparatus 20 may be implemented in hardware, software, or any combination thereof. For example, hardware implementations may include configurable logic such as, for example, PLAs, FPGAs, CPLDs, or fixed-functionality logic hardware using circuit technology such as, for example, ASIC, CMOS, or TTL technology, or any combination thereof.

Alternatively, or additionally, these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

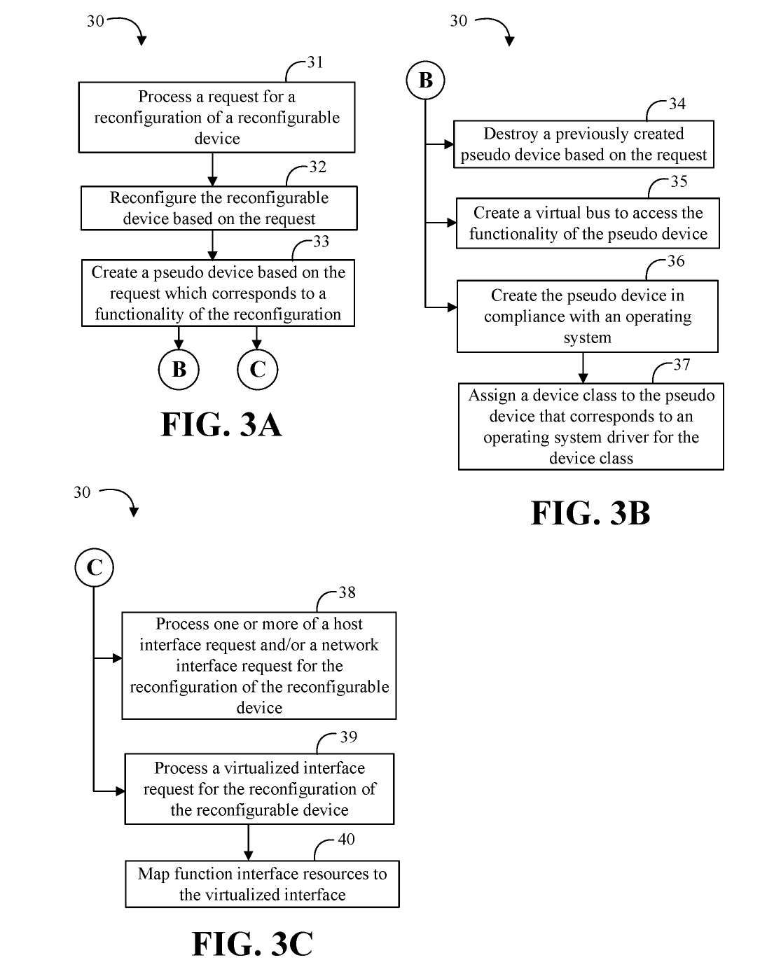

Turning now to FIGS. 3A to 3C, an embodiment of a method 30 of managing a device may include processing a request for a reconfiguration of a reconfigurable device at block 31, reconfiguring the reconfigurable device based on the request, at block 32, and creating a pseudo device based on the request which corresponds to a functionality of the reconfiguration at block 33. For example, the pseudo-device may be a virtual device or may appear to be a physical device. The method 30 may further include destroying a previously created pseudo device based on the request at block 34, and/or creating a virtual bus to access the functionality of the pseudo device at block 35.

Some embodiments of the method 30 may further include creating the pseudo device in compliance with an OS at block 36, and assigning a device class to the pseudo device that corresponds to an OS driver for the device class at block 37. Some embodiments of the method 30 may also include processing one or more of a host interface request and/or a network interface request for the reconfiguration of the reconfigurable device at block 38. Some embodiments may also include processing a virtualized interface request for the reconfiguration of the reconfigurable device at block 39, and mapping function interface resources to the virtualized interface at block 40.

Embodiments of the method 30 may be implemented in a system, apparatus, processor, reconfigurable device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages. For example, the method 30 may be implemented on a non-transitory computer readable medium as described in connection with Examples 19 to 25 below. For example, embodiments or portions of the method 30 may be implemented in applications (e.g., through an application programming interface (API)) or driver software running on an OS.

Some embodiments may advantageously provide for efficiently managing dynamically reconfigurable hardware. Reconfigurable devices such as FPGAs may be important for various computing scenarios including, for example, in a datacenter or for various internet-of-things (IoT) usages. An example value proposition of such devices is that they may be dynamically reconfigured during system operation. At one instance, the device might have a compression persona while at another, it may have an encryption persona, a networking persona, a machine-learning persona, etc. Managing such changes may fall into the system software domain but conventional OS driver stacks may have limited capability to manage a dynamically reconfigurable device during runtime and/or may have no efficient mechanism to tear-down and build-up a driver stack in response to a persona change in such a reconfigurable device.

Advantageously, some embodiments may provide a hardware/software technique for handling such dynamically reconfigurable devices in both non-virtualized and virtualized system environments. For example, some embodiments may dynamically create and destroy virtual devices that represent individual functionality within a reconfigurable device (e.g., an FPGA). A reconfigurable device may be dynamically morphed to appear as a completely new kind of device exposing a completely different functionality, essentially becoming a completely new set of resources. In a heterogeneous system configuration, there may be many such reconfigurable devices to provide, for example, compute and/or input/output (IO) acceleration in addition to processors or central processor units (CPUs). In accordance with some embodiments, virtual devices may be created to represent dynamically configured physical resources, such as memory-mapped IO (MMIO) regions, interrupts, and system memory, in a manner that can be dynamically handled by system and/or virtualization software, while also ensuring an efficient CPU-to-reconfigurable device communication.

One approach to handle a reconfigured device in a system may require a reboot of the system. This approach may have significant drawbacks in the amount of time required to reboot and halting other applications running on the system. Reboot may not be practical in various scenarios such as cloud data centers, and some IoT usages (e.g., self-driving automobiles). Another approach may involve simulating a hot plug event for the reconfigured device. The simulated hot-plug approach may require additional hardware support to simulate the hot-plug sequence (e.g., by requiring electrical isolation from the device interconnect), may not support multiple functions in a single package (e.g., or may interrupt current functions to add a new function), and may be unreliable due to the complexity of hot-plug mechanisms. Another approach may involve hiding the persona change from the OS. Hiding the persona change from the OS, however, may preclude the applicability of the reconfigured device to portions of the OS that do not have visibility into the device (e.g., kernel mode usage scenarios). All the foregoing approaches introduce various compromises that may reduce the value proposition of the reconfigurable device.

In accordance with some embodiments, functions or portions of a reconfigurable device may be represented as virtual devices that may be dynamically instantiated and torn down without requiring a reboot or a hot-plug event. For example, virtual devices may be created in a form that is compliant with and known to the existing OS software. The OS-compliant virtual devices may allow OS and/or other kernel-mode software to utilize services implemented by the virtual device along with traditional application or user-mode usages.

In some embodiments, attributes or characteristics may be associated with each virtual device that may allow a user or system designer to override the device class of the underlying physical device such that the virtual device may appear to be a different device class. Having an appropriate device class assigned to the virtual device may allow existing class or device drivers to load without modification and utilize the virtual device.

For example, using this technique a network interface card (NIC) functionality may be implemented on an FPGA device while utilizing existing NIC drivers and OS infrastructure. In another example, the ability to load existing drivers may also enable software developers to implement pre-silicon validation of driver, software stack and register transfer logic (RTL) for a new device by initially implementing the new device on an FPGA. When the silicon for the new device (e.g., an ASIC) is ready, the drivers may be able to be deployed having already been debugged.

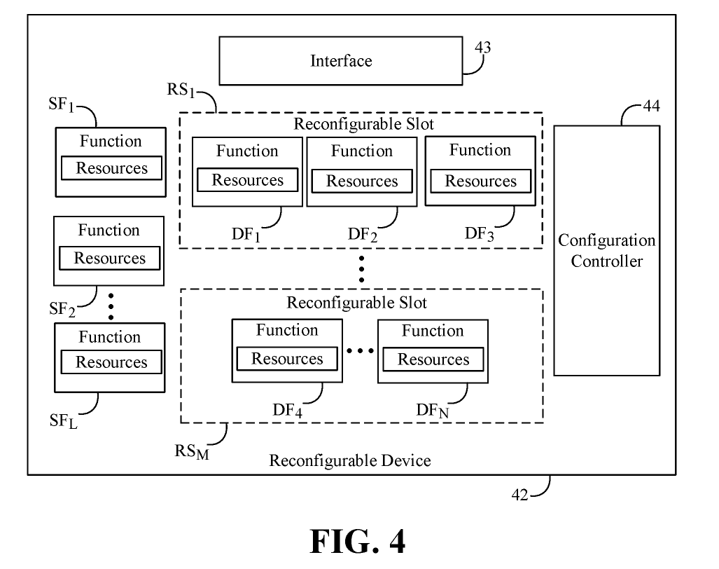

Turning now to FIG. 4, an embodiment of a reconfigurable device 42 may include an interface 43 to process a request for a reconfiguration of the reconfigurable device 42, and a configuration controller 44 to reconfigure the reconfigurable device 42 based on the request. The reconfigurable device 42 may optionally include one or more static functions SF₁ through SF_{L} (L>1), and one or more reconfigurable slots RS₁ through RS_{M} (M>1). Each of the reconfigurable slots RS₁ through RS_{M} may be configured with one or more dynamic functions DF₁ through DF_{N} (N>1). For example, the dynamic functions may include one or more reconfigurable accelerators. For example, the interface 43 may be a host interface. For example, the host interface may support a Peripheral Component Interconnect (PCI) bus, a PCI Express bus, a QuickPath Interconnect (QPI) bus, etc. In addition, or alternatively, the interface 43 may be a network interface (e.g., a remote interface).

In some embodiments, the static functions may always be present as part of the reconfigurable device 42, whereas the dynamic functions may be created as new functions and/or removed by the configuration controller 44. Each of the static and dynamic functions may include various device interface resources, such as but not limited to MMIO regions, interrupts, resets, direct memory access (DMA) channels, etc., through which host/network software may communicate with or otherwise utilize the functions of the reconfigurable device 42. For example, MMIO regions for the functions of the reconfigurable device 42 may be scattered/partitioned (e.g., if required) to allow system software to map privileged MMIO to privileged software and expose nonprivileged resources directly to an application domain for fast-path communication. In some embodiments, existing mechanisms of page-table mapping may be used in connection with the reconfigurable device 42.

Some embodiments may advantageously partially reconfigure the reconfigurable device 42 to dynamically reconfigure one or more reconfigurable slots and dynamically instantiate the corresponding software stack for use by the requester. The persona of the reconfigurable slots may advantageously be respectively changed by instantiation and teardown. For example, the software stack may be torn down once the requester is done with the persona. The software stacks may also be torn down when another request displaces the current persona. In some embodiments, the reconfigurable device 42 may be part of a multi-chip package (MCP) such as an INTEL XEON+FPGA MCP. In some embodiments, the reconfigurable device 42 may be part of a Discrete Configurable Platform (DCP).

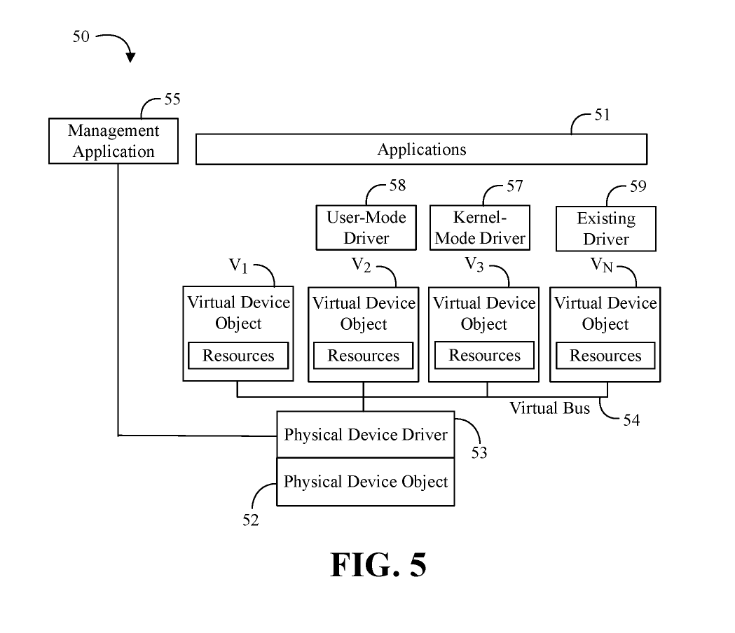

Turning now to FIG. 5, an embodiment of a general software architecture 50 according to an embodiment may be applicable to a non-virtualized environment in which host applications 51, management applications 55, and/or system software may manage a reconfigurable device and communicate with functions in the reconfigurable device. At the bottom of the software stack, a physical device object 52 (e.g., a software representation of the reconfigurable device) may be created by the system software when it detects or determines the presence of the reconfigurable device in the system (e.g., through PCI, advanced configuration and power interface (ACPI), universal serial bus (USB), etc.). For example, plug-and-play functionality implemented in the OS may automatically load a physical device driver 53 for the physical device object 52 (e.g., presuming the driver is available or installed). Advantageously, some embodiments may implement bus functionality in the physical device driver 53 and create or expose a virtual bus 54 where each function or portion of the reconfigurable device may be represented as a virtual device that may be instantiated or torn down dynamically based on the persona(s) programmed on the reconfigurable device (e.g., as requested by the higher-level software or entity such as a management application 55, orchestration layer, system administrator, system user, etc.).

For example, an embodiment may include a reconfigurable device with two reconfigurable slots in an initial state without any particular persona or functionality programmed. The management application 55 may request the physical device driver 53 to program a compression function with three independent engines in the first reconfigurable slot. The physical device driver 53 may reprogram the physical hardware, query the capabilities, and based on the queried capabilities, the driver 53 may then create three virtual devices on the virtual bus. Each of the virtual devices may respectively represent one of the three compression engines programmed in the first reconfigurable slot of the reconfigurable device. These virtual devices may be enumerated on the virtual bus 54 and may be represented with virtual device objects (e.g., objects V₁ through V_{N}) for which system software may load various independent software stacks (e.g., kernel-mode (KM) driver 57, user-mode (UM) driver 58, existing device or class driver 59, etc.).

Subsequently, the management application 55 and/or host applications 51 may request the device driver 53 to reprogram the first reconfigurable slot with an encryption function containing two independent engines. The physical device driver 53 may first tear down the existing virtual devices and device drivers associated with that slot, reprogram the slot, and then create two new virtual devices representing the two encryption engines. In some embodiments, the physical device driver 53 may be responsible for managing the life cycle of functions in the reconfigurable device. For example, the physical device driver 53 may interact with the hardware to initiate reconfiguration activities, and may also interact with the OS to facilitate the creation and destruction of the virtual device objects that correspond with functions in the hardware.

In some embodiments, the physical device driver 53 may create or request creation of child virtual device objects representing respective functions in the reconfigurable device. Each of these virtual device objects may be augmented with separate MMIO, interrupts, or other capabilities/resources providing an interface to a higher-level software stack as if they were separate physical devices. The virtual device objects may also provide a mechanism (e.g., through APIs) to interact with resources that cannot be directly assigned, such as shared interrupts or MMIO regions. Because the physical driver 53 may distribute resources (e.g., MMIO, interrupts etc.) among the virtual devices, the driver 53 may assure software-level isolation between the virtual devices as long the resources are not interrelated. For example, the driver 53 may provide mapping and APIs such that interface resource isolation is maintained between the virtual devices as needed.

In some embodiments, the virtual device objects may be created and/or augmented with resources in a form that is known to the OS. Advantageously, an existing driver stack may be loaded and/or existing software may be used if the MMIO and interrupt layout for the virtual device object is compatible with the real physical device for which the original software was built. For example, an off-the-shelf gigabit Ethernet controller may be programmed in an FPGA and the created virtual device may expose the same hardware resources (MMIO, interrupts, ports etc.) as the real device. Advantageously, the virtual device may be a pseudo device that appears to be a real device. Advantageously, some embodiments may also expose new functionality that may be exposed through an entirely new software stack. In some embodiments, both a legacy function and a new function may be supported by the same reconfigurable device at the same time (e.g., the reconfigurable device may support any of a number of programmed functions with appropriate corresponding virtual devices). In some embodiments, a runtime application may be loaded to map interface resources appropriately to the user space, when feasible, or to provide APIs to allow access to resources, or alternatively, when a direct map is not desirable

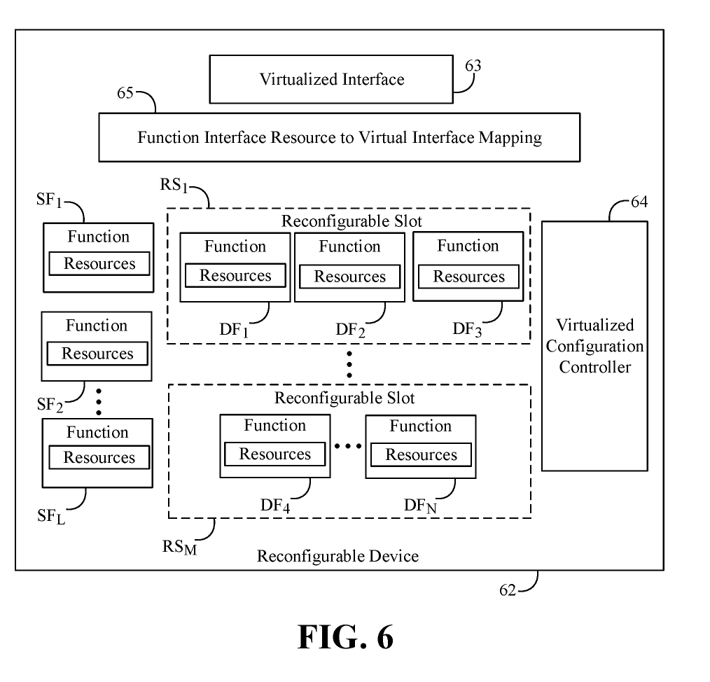

Turning now to FIG. 6, an embodiment of a reconfigurable device 62 may include a virtualized interface 63 to process a request for a reconfiguration of the reconfigurable device 62, and a virtualized configuration controller 64 to reconfigure the reconfigurable device 62 based on the request. The reconfigurable device 62 may optionally include one or more static functions SF₁ through SF_{L} (L>1), and one or more reconfigurable slots RS₁ through RS_{M} (M>1). Each of the reconfigurable slots RS₁ through RS_{M} may be configured with one or more dynamic functions DF₁ through DF_{N} (N>1). For example, the virtualized interface 63 may be a virtualized host interface. For example, the virtualized host interface may support IO virtualization (IOV) such as scalable IOV, single root IOV (SR-IOV), multi-root IOV (MR-IOV), etc. In addition, or alternatively, the virtualized interface 63 may be a virtualized network interface (e.g., a transport such as PCI Express-over-Ethernet). The device 62 may include a dynamic mapping layer 65 to map function interface resources to the appropriate virtualized host/network interface.

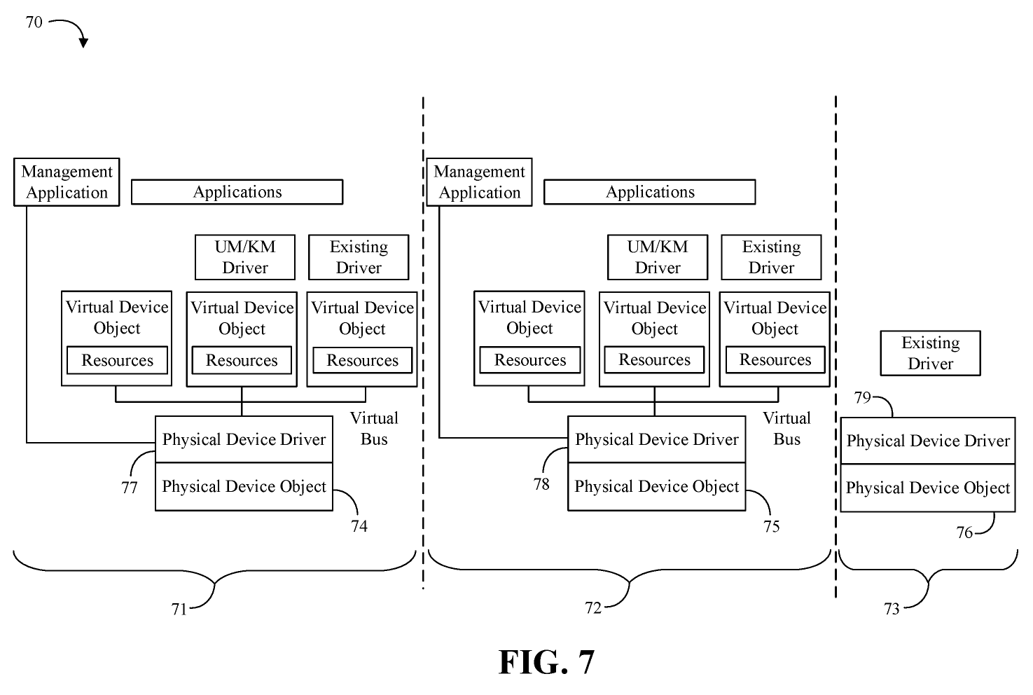

Turning now to FIG. 7, an embodiment of a virtualization environment 70 may include a host portion 71, a first guest virtual machine (VM) portion 72, and a second guest VM portion 73. The host portion 71 may include a software architecture which is similar to the architecture 50 discussed above (FIG. 5), with a physical device object 74 which may correspond to a physical reconfigurable device. The guest VMs may also include a similar software stack with respective physical device objects 75 and 76 which may correspond to virtual functions (VFs) and/or virtual devices (VDEVs). Advantageously, all of the physical device objects 74, 75, and 76 may be controlling different functions on the same reconfigurable device (e.g., such as device 62 from FIG. 6).

In some embodiments, the physical device driver 77 on the host portion 71 may map device resources or functions to virtualized host channels. One example of resource mapping may include the host mapping the ability to reconfigure slot RS₁, in FIG. 6, to a VM while keeping the ability to reconfigure slot RS_{N} to itself. The guest VM device drivers 78, 79 may have control over the exposed MMIO regions and interrupts of their respective virtualized devices. The guest VM device driver 78, 79 may bind to a virtualized device object, such as a PCI VF or scalable IOV VDEV, rather than the physical device. With the exception of APIs for mapping resources and/or functions to virtualized host channels, the guest VM device driver 78, 79 may advantageously be functionally similar or identical to the physical device driver 77 present on the host portion 71. The physical device driver 77 on the host portion 71 may virtualize PCI configuration space and allow existing device drivers to load on the device exposed to the guest VM. One virtual device generally may not access the interface resources assigned to another virtual device. An example mechanism for ensuring security is to utilize CPU page protection mechanisms on MMIO regions in order to assign specific functional portions to individual devices.

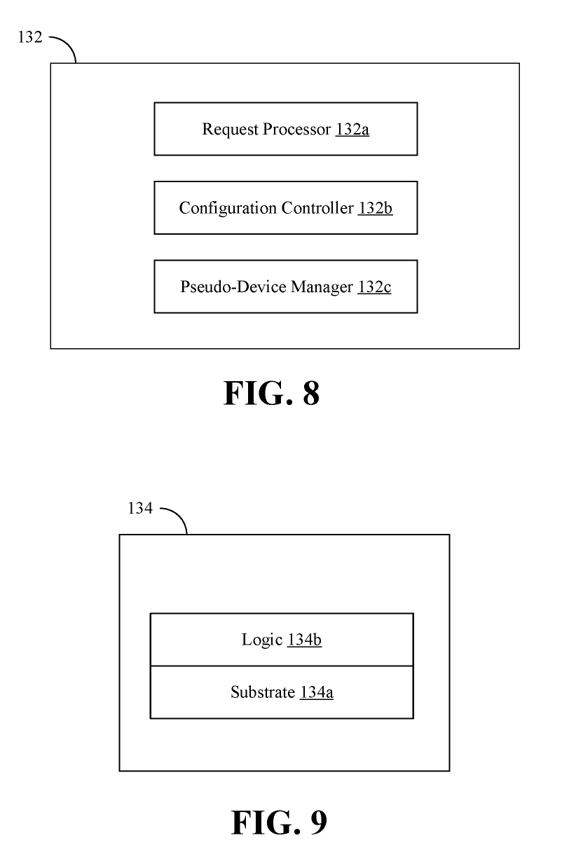

FIG. 8 shows a device manager apparatus 132 (132a-132c) that may implement one or more aspects of the method 30 (FIGS. 3A to 3C). The device manager apparatus 132, which may include logic instructions, configurable logic, fixed-functionality hardware logic, may be readily substituted for the device manager 14 (FIG. 1), already discussed. A request processor 132a may process a request for a reconfiguration of a reconfigurable device. A configuration controller 132b may reconfigure the reconfigurable device based on the request. A pseudo-device manager 132c may create a pseudo device based on the request which corresponds to a functionality of the reconfiguration. The pseudo-device manager 132c may also destroy a previously created pseudo device based on the request. For example, the pseudo-device manager 132c may also create a virtual bus to access the functionality of the pseudo device.

In some embodiments, the pseudo-device manager 132c may create the pseudo device in compliance with an OS. For example, the pseudo-device manager 132c may assign a device class to the pseudo device that corresponds to an OS driver for the device class. In any of the foregoing examples, the request processor 132a may comprise one or more of a host interface and/or a network interface. In a virtualization environment, for example, the request processor 132a may comprise a virtualized interface and the configuration controller 132b may comprise a virtualized configuration controller. For the virtualization environment, for example, the apparatus 132 may include a mapping layer to map function interface resources to the virtualized interface.

Turning now to FIG. 9, device manager apparatus 134 (134a, 134b) is shown in which logic 134b (e.g., transistor array and other integrated circuit/IC components) is coupled to a substrate 134a (e.g., silicon, sapphire, gallium arsenide). The logic 134b may generally implement one or more aspects of the method 30 (FIGS. 3A to 3C). Thus, the logic 134b may process a request for a reconfiguration of a reconfigurable device, reconfigure the reconfigurable device based on the request, and create a pseudo device based on the request which corresponds to a functionality of the reconfiguration. The logic 134b may also destroy a previously created pseudo device based on the request and/or create a virtual bus to access the functionality of the pseudo device. In some embodiments, the logic 134b may create the pseudo device in compliance with an OS, and/or assign a device class to the pseudo device that corresponds to an OS driver for the device class. For a virtualization environment, for example, the logic 134b may provide a mapping layer to map function interface resources. In one example, the apparatus 134 is a semiconductor die, chip and/or package.

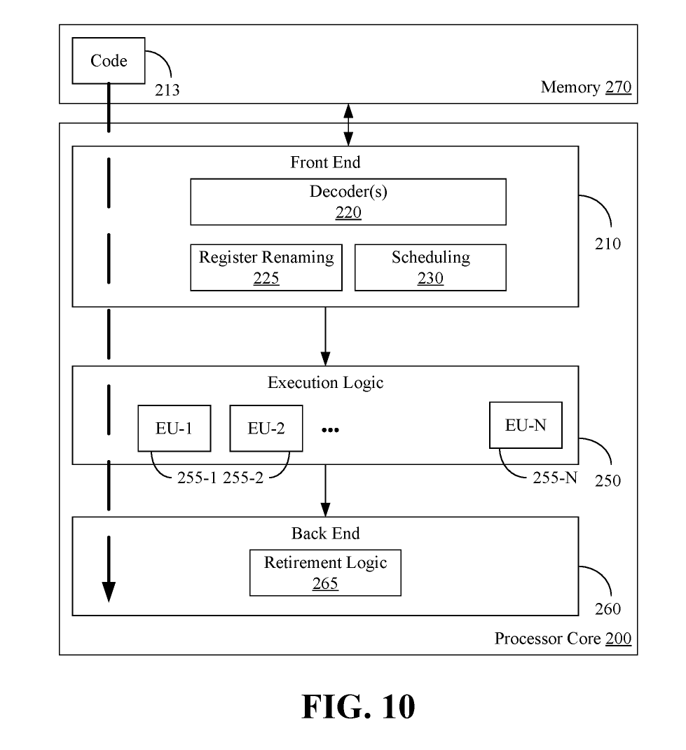

FIG. 10 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 10, a processing element may alternatively include more than one of the processor core 200 illustrated in FIG. 10. The processor core 200 may be a single-threaded core or, for at least one embodiment, the processor core 200 may be multithreaded in that it may include more than one hardware thread context (or “logical processor”) per core.

FIG. 10 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the method 30 (FIGS. 3A to 3C), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 10, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

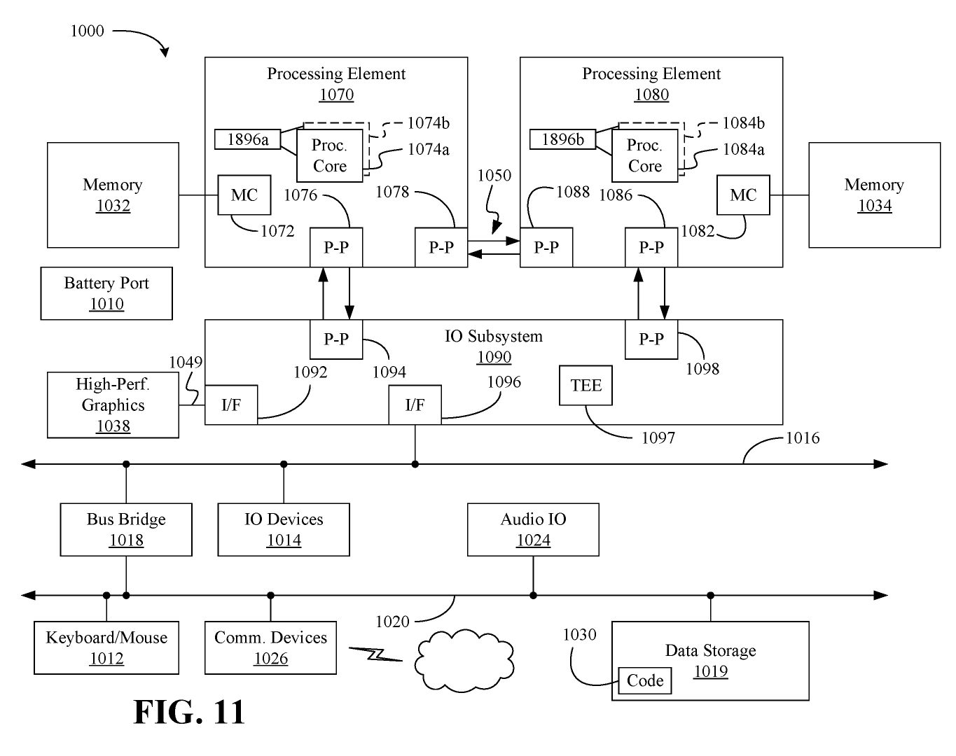

Referring now to FIG. 11, shown is a block diagram of a system 1000 embodiment in accordance with an embodiment. Shown in FIG. 11 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 11 may be implemented as a multi-drop bus rather than point-to-point interconnect.

As shown in FIG. 11, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 10.

Each processing element 1070, 1080 may include at least one shared cache 1896a, 1896b (e.g., static random access memory/SRAM). The shared cache 1896a, 1896b may store data (e.g., objects, instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 11, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 11, the I/O subsystem 1090 includes a TEE 1097 (e.g., security controller) and P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 11, various I/O devices 1014 (e.g., cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement one or more aspects of the method 30 (FIGS. 3A to 3C), already discussed, and may be similar to the code 213 (FIG. 10), already discussed. Further, an audio I/O 1024 may be coupled to second bus 1020.

Note that other embodiments are contemplated. For example, instead of the point-to-point architecture of FIG. 11, a system may implement a multi-drop bus or another such communication topology.

### Additional Notes and Examples

Example 1 may include an electronic processing system, comprising a processor, persistent storage media communicatively coupled to the processor, a reconfigurable device communicatively coupled to the processor, and a device manager communicatively coupled to the reconfigurable device to dynamically reconfigure the reconfigurable device at runtime, the reconfigurable device manager including a request processor to process a request for a reconfiguration of the reconfigurable device, a configuration controller to reconfigure the reconfigurable device based on the request, and a pseudo-device manager to create a pseudo device based on the request which corresponds to a functionality of the reconfiguration.

Example 2 may include the system of Example 1, wherein the pseudo-device manager is further to create a virtual bus to access the functionality of the pseudo device.

Example 3 may include the system of any of Examples 1 to 2, wherein the request processor comprises one or more of a host interface and a network interface.

Example 4 may include a device manager apparatus, comprising a request processor to process a request for a reconfiguration of a reconfigurable device, a configuration controller communicatively coupled to the request processor to reconfigure the reconfigurable device based on the request, and a pseudo-device manager communicatively coupled to the request processor to create a pseudo device based on the request which corresponds to a functionality of the reconfiguration.

Example 5 may include the apparatus of Example 4, wherein the pseudo-device manager is further to destroy a previously created pseudo device based on the request.

Example 6 may include the apparatus of Example 4, wherein the pseudo-device manager is further to create a virtual bus to access the functionality of the pseudo device.

Example 7 may include the apparatus of Example 6, wherein the pseudo-device manager is further to create the pseudo device in compliance with an operating system.

Example 8 may include the apparatus of Example 7, wherein the pseudo-device manager is further to assign a device class to the pseudo device that corresponds to an operating system driver for the device class.

Example 9 may include the apparatus of any of Examples 4 to 8, wherein the request processor comprises a host interface.

Example 10 may include the apparatus of any of Examples 4 to 8, wherein the request processor comprises a network interface.

Example 11 may include the apparatus of any of Examples 4 to 8, wherein the request processor comprises a virtualized interface and wherein the configuration controller comprises a virtualized configuration controller, and a mapping layer to map function interface resources to the virtualized interface.

Example 12 may include a method of managing a device, comprising processing a request for a reconfiguration of a reconfigurable device, reconfiguring the reconfigurable device based on the request, and creating a pseudo device based on the request which corresponds to a functionality of the reconfiguration.

Example 13 may include the method of Example 12, further comprising destroying a previously created pseudo device based on the request.

Example 14 may include the method of Example 12, further comprising creating a virtual bus to access the functionality of the pseudo device.

Example 15 may include the method of Example 14, further comprising creating the pseudo device in compliance with an operating system.

Example 16 may include the method of Example 15, further comprising assigning a device class to the pseudo device that corresponds to an operating system driver for the device class.

Example 17 may include the method of any of Examples 12 to 16, further comprising processing one or more of a host interface request and a network interface request for the reconfiguration of the reconfigurable device.

Example 18 may include the method of any of Examples 12 to 16, further comprising processing a virtualized interface request for the reconfiguration of the reconfigurable device, and mapping function interface resources to the virtualized interface.

Example 19 may include at least one non-transitory computer readable medium, comprising a set of instructions, which when executed by a computing device, cause the computing device to process a request for a reconfiguration of a reconfigurable device, reconfigure the reconfigurable device based on the request, and create a pseudo device based on the request which corresponds to a functionality of the reconfiguration.

Example 20 may include the at least one non-transitory computer readable medium of Example 19, comprising a further set of instructions, which when executed by a computing device, cause the computing device to destroy a previously created pseudo device based on the request.

Example 21 may include the at least one non-transitory computer readable medium of Example 19, comprising a further set of instructions, which when executed by a computing device, cause the computing device to create a virtual bus to access the functionality of the pseudo device.

Example 22 may include the at least one non-transitory computer readable medium of Example 21, comprising a further set of instructions, which when executed by a computing device, cause the computing device to create the pseudo device in compliance with an operating system.

Example 23 may include the at least one non-transitory computer readable medium of Example 22, comprising a further set of instructions, which when executed by a computing device, cause the computing device to assign a device class to the pseudo device that corresponds to an operating system driver for the device class.

Example 24 may include the at least one non-transitory computer readable medium of any of Examples 19 to 23, comprising a further set of instructions, which when executed by a computing device, cause the computing device to process one or more of a host interface request and a network interface request for the reconfiguration of the reconfigurable device.

Example 25 may include the at least one non-transitory computer readable medium of any of Examples 19 to 23, comprising a further set of instructions, which when executed by a computing device, cause the computing device to process a virtualized interface request for the reconfiguration of the reconfigurable device, and map function interface resources to the virtualized interface.

Example 26 may include a device manager apparatus, comprising means for processing a request for a reconfiguration of a reconfigurable device, means for reconfiguring the reconfigurable device based on the request, and means for creating a pseudo device based on the request which corresponds to a functionality of the reconfiguration.

Example 27 may include the apparatus of Example 26, further comprising means for destroying a previously created pseudo device based on the request.

Example 28 may include the apparatus of Example 26, further comprising means for creating a virtual bus to access the functionality of the pseudo device.

Example 29 may include the apparatus of Example 28, further comprising means for creating the pseudo device in compliance with an operating system.

Example 30 may include the apparatus of Example 29, further comprising means for assigning a device class to the pseudo device that corresponds to an operating system driver for the device class.

Example 31 may include the apparatus of any of Examples 26 to 30, further comprising means for processing one or more of a host interface request and a network interface request for the reconfiguration of the reconfigurable device.

Example 32 may include the apparatus of any of Examples 26 to 30, further comprising means for processing a virtualized interface request for the reconfiguration of the reconfigurable device, and means for mapping function interface resources to the virtualized interface.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B, and C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
a processor;
persistent storage media communicatively coupled to the processor;
a reconfigurable device communicatively coupled to the processor; and
a device manager communicatively coupled to the reconfigurable device to dynamically reconfigure the reconfigurable device at runtime, the reconfigurable device manager including:
a request processor to process a request for a reconfiguration of the reconfigurable device,
a configuration controller to reconfigure the reconfigurable device based on the request, and
a pseudo-device manager to create a pseudo device based on the request which corresponds to a functionality of the reconfiguration.

2. The system of claim 1, wherein the pseudo-device manager is further to create a virtual bus to access the functionality of the pseudo device.

3. The system of claim 1, wherein the request processor comprises one or more of a host interface and a network interface.

4. A device manager apparatus, comprising:
a request processor to process a request for a reconfiguration of a reconfigurable device;
a configuration controller communicatively coupled to the request processor to reconfigure the reconfigurable device based on the request; and
a pseudo-device manager communicatively coupled to the request processor to create a pseudo device based on the request which corresponds to a functionality of the reconfiguration.

5. The apparatus of claim 4, wherein the pseudo-device manager is further to destroy a previously created pseudo device based on the request.

6. The apparatus of claim 4, wherein the pseudo-device manager is further to create a virtual bus to access the functionality of the pseudo device.

7. The apparatus of claim 6, wherein the pseudo-device manager is further to create the pseudo device in compliance with an operating system.

8. The apparatus of claim 7, wherein the pseudo-device manager is further to assign a device class to the pseudo device that corresponds to an operating system driver for the device class.

9. The apparatus of claim 4, wherein the request processor comprises a host interface.

10. The apparatus of claim 4, wherein the request processor comprises a network interface.

11. The apparatus of claim 4, wherein the request processor comprises a virtualized interface and wherein the configuration controller comprises a virtualized configuration controller, and wherein the apparatus further includes a mapping layer to map function interface resources to the virtualized interface.

12. A method of managing a device, comprising:
processing a request for a reconfiguration of a reconfigurable device;
reconfiguring the reconfigurable device based on the request; and
creating a pseudo device based on the request which corresponds to a functionality of the reconfiguration.

13. The method of claim 12, further comprising:
destroying a previously created pseudo device based on the request.

14. The method of claim 12, further comprising:
creating a virtual bus to access the functionality of the pseudo device.

15. The method of claim 14, further comprising:
creating the pseudo device in compliance with an operating system.

16. The method of claim 15, further comprising:
assigning a device class to the pseudo device that corresponds to an operating system driver for the device class.

17. The method of claim 12, further comprising:
processing one or more of a host interface request and a network interface request for the reconfiguration of the reconfigurable device.

18. The method of claim 12, further comprising:
processing a virtualized interface request for the reconfiguration of the reconfigurable device; and
mapping function interface resources to the virtualized interface.

19. At least one non-transitory computer readable medium, comprising a set of instructions, which when executed by a computing device, cause the computing device to:
process a request for a reconfiguration of a reconfigurable device;
reconfigure the reconfigurable device based on the request; and
create a pseudo device based on the request which corresponds to a functionality of the reconfiguration.

20. The at least one non-transitory computer readable medium of claim 19, comprising a further set of instructions, which when executed by a computing device, cause the computing device to:
destroy a previously created pseudo device based on the request.

21. The at least one non-transitory computer readable medium of claim 19, comprising a further set of instructions, which when executed by a computing device, cause the computing device to:
create a virtual bus to access the functionality of the pseudo device.

22. The at least one non-transitory computer readable medium of claim 21, comprising a further set of instructions, which when executed by a computing device, cause the computing device to:
create the pseudo device in compliance with an operating system.

23. The at least one non-transitory computer readable medium of claim 22, comprising a further set of instructions, which when executed by a computing device, cause the computing device to:
assign a device class to the pseudo device that corresponds to an operating system driver for the device class.

24. The at least one non-transitory computer readable medium of claim 19, comprising a further set of instructions, which when executed by a computing device, cause the computing device to:
process one or more of a host interface request and a network interface request for the reconfiguration of the reconfigurable device.

25. The at least one non-transitory computer readable medium of claim 19, comprising a further set of instructions, which when executed by a computing device, cause the computing device to:
process a virtualized interface request for the reconfiguration of the reconfigurable device; and
map function interface resources to the virtualized interface.
